(19) United States
(12) Patent Application Publication
(10) Pub. No.: US 2011/0017761 A1
(43) Pub. Date: Jan. 27, 2011

(54) METHOD AND DEVICE FOR TRANSFERRING PRODUCTS IN A VENDING MACHINE

(75) Inventor: Aristide Domenico Roncari, Paderno Dugnano (IT)

Correspondence Address: Workman Nydegger;1000 Eagle Gate Tower, 60 East South Temple, Salt Lake City, UT, 84111, US

(73) Assignee: N & W GLOBAL VENDING S.P.A., Valbrembo (IT)

(21) Appl. No.: 12/747,509

(22) PCT Filed: Mar. 28, 2008
(86) PCT No.: PCT/IB08/00739

§ 371 Date: Oct. 11, 2010

(30) Foreign Application Priority Data
Dec. 11, 2007 (IT) TO2007A000894

(51) Int. Cl. G07F 11/38; B65D 83/00

(52) U.S. Cl. 221/1; 221/208; 221/97

(57) ABSTRACT

A method and device for transferring products in a vending machine, whereby a selected product is transferred from a relative fixed tray of the machine to a catch bin by a transfer member movable along a chute and designed to selectively assume two configurations, a first of which is a concave configuration to control the position of the selected product as it moves down the chute, and a second of which is a configuration allowing the selected product to drop freely along the chute, and which leaves the chute clear.

### TECHNICAL FIELD

The present invention relates to a method and device for transferring products in a vending machine.

### BACKGROUND ART

As is known, vending machines comprise a cabinet or similar container defining a compartment closed at the front by a door normally made at least partly of transparent material. Fixed trays are normally fitted one over the other inside the compartment to support respective numbers of products, such as bottles, cans, boxes or bags arranged in columns perpendicular to the door, and occupy a rear portion of the compartment so as to define, between the front ends of the trays and the door, a chute communicating at the bottom with a catch bin in the base of the machine.

Each column is normally engaged by a respective conveyor, normally a push conveyor, which is user-activated selectively to feed the products successively into the chute.

Known vending machines are also fitted, inside the chute, with a transfer device or elevator comprising a movable shelf, which is moved along the chute and aligned selectively with the trays to receive the user-selected product, and is then lowered and stopped in a position immediately over the bin, where it is rotated to unload the selected product into the bin.

This prevents damage to the selected products, especially those on the top trays, by easing them, as opposed to falling freely, along the chute, but still involves a number of drawbacks, mainly due to known movable shelves failing to control the position of, and stabilize, the products as they moved down the chute. As a result, the selected products, allowed to move on the movable shelf as it moves down, may interfere with the products on the fixed trays, thus damaging them and themselves, as well as with the movable shelf actuating mechanisms, thus jamming the machine as a whole. Moreover, when they jam along the chute, due to a malfunction or for any other reason, known movable shelves make it impossible to drop-feed the products into the bin, thus putting the whole machine out of service.

DISCLOSURE OF INVENTION

It is an object of the present invention to provide a method of transferring products in a vending machine, which is cheap and easy to implement, and, at the same time, provides for partly or completely eliminating the aforementioned drawbacks.

According to the present invention, there is provided a method of transferring products in a vending machine, as claimed in claim 1 and preferably in any one of the following Claims depending directly or indirectly on claim 1.

According to the present invention, there is also provided a device for transferring products in a vending machine, as claimed in claim 15 and preferably in any one of the following Claims depending directly or indirectly on claim 15.

### BRIEF DESCRIPTION OF THE DRAWINGS

A number of non-limiting embodiments of the present invention will be described by way of example with reference to the accompanying drawings, in which:

FIGS. 1 and 2 show views in perspective, with parts removed for clarity, of a vending machine featuring a first preferred embodiment of the transfer device according to the present invention in respective different operating positions;

FIG. 3 shows a larger-scale, schematic view in perspective of the FIGS. 1 and 2 transfer device in a given operating position;

FIG. 4 shows a larger-scale first detail of FIG. 3;

FIGS. 5, 6, 7 show larger-scale side views, from the inside, of a second detail of FIG. 3 in respective different operating positions;

FIG. 8 shows a side view, from the outside, of a detail in FIGS. 5 to 7;

FIG. 9 shows a section along line IX-IX in FIG. 5;

FIG. 10 shows a section along line X-X in FIG. 9;

FIG. 11 shows a view in perspective, with parts removed for clarity, of a vending machine featuring a second preferred embodiment of the transfer device according to the present invention;

FIG. 12 shows a larger-scale, schematic view in perspective of the FIG. 11 transfer device in a given operating position;

FIG. 13 shows a larger-scale detail of FIG. 12;

FIG. 14 shows a larger-scale, different view in perspective of a further detail of FIG. 11;

FIGS. 15 to 18 show partly sectioned side views, from the inside, of the FIG. 14 detail in respective different operating positions;

FIG. 19 shows a partly sectioned, partial plan view of the FIG. 12 transfer device;

FIG. 20 shows a side view of a detail of FIG. 19;

FIG. 21 shows a larger-scale view in perspective of a variation of the FIG. 7 detail;

FIGS. 22 to 24 show side views of the FIG. 21 variation in respective different operating positions.

### BEST MODE FOR CARRYING OUT THE INVENTION

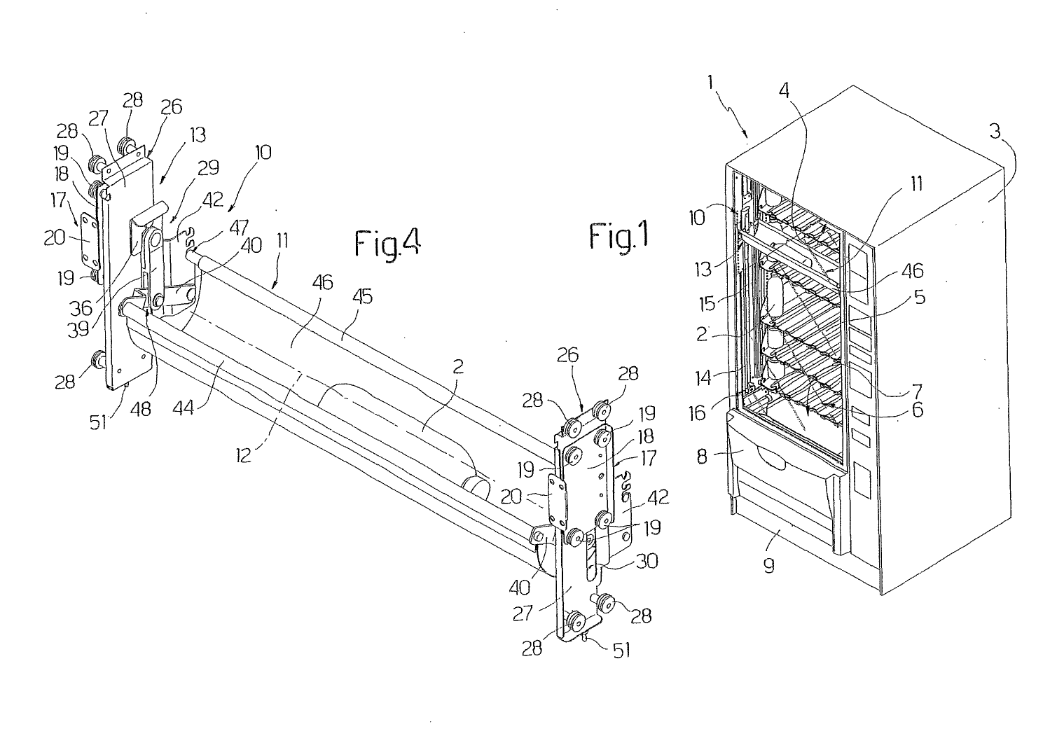

Number 1 in FIGS. 1, 2 and 11 indicates as a whole a vending machine for products 2, comprising a cabinet 3 defining a top compartment 4 housing a number of superimposed trays 5, each supporting a number of orderly columns of products 2. Compartment 4 is closed at the front by a door 6 substantially perpendicular to the columns of products 2 and defining, with the front ends of trays 5, a substantially vertical chute 7, into which the user-selected products 2 are fed by known push conveyors (not shown), and which communicates with a catch bin 8 housed in the base 9 of cabinet 3, beneath door 6.

Vending machine 1 also comprises a transfer device 10 housed inside chute 7 and for transferring a user-selected product 2 from respective tray 5 to bin 8.

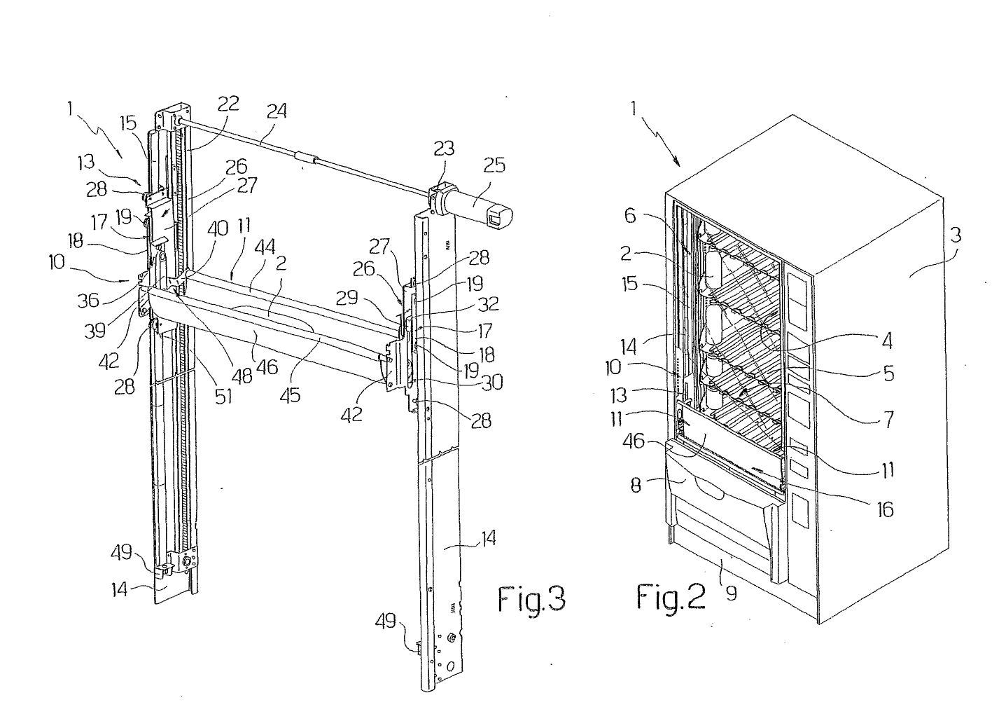

Transfer device 10 comprises a transfer member 11 for receiving selected products 2, and extending along a substantially horizontal longitudinal axis 12 parallel to door 6; and an actuating assembly 13 for moving transfer member 11 along chute 7 between a top pickup position (FIGS. 1 and 11), in which transfer member 11 is substantially aligned with a tray 5 supporting a selected product 2, and a bottom unloading position (FIG. 2), in which the selected product 2 is unloaded into bin 8.

Transfer member 11, which is described in detail below, may, depending on its location along chute 7, assume either of two alternative configurations a first substantially concave configuration, with its concavity facing upwards, in which transfer member 11 retains selected products 2; and a second, unloading, configuration (shown in FIGS. 2, 7, 18), in which selected product 2 is allowed to drop freely into bin 8.

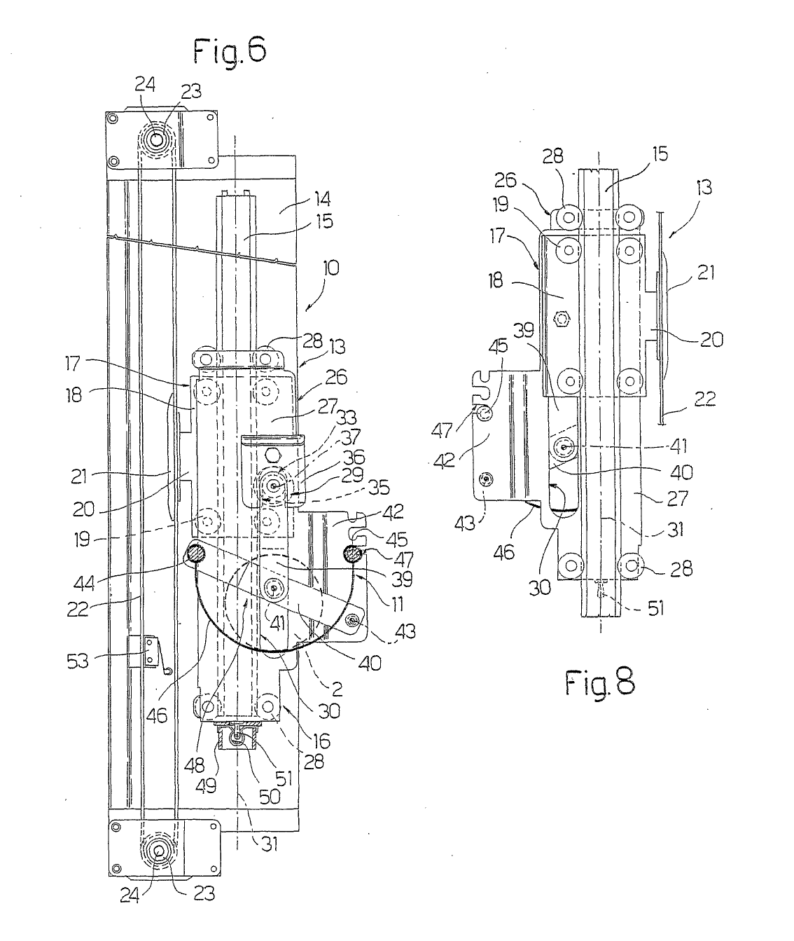

In the FIG. 1-10 embodiment, and as shown more clearly in FIG. 1 and particularly FIG. 3, actuating assembly 13 comprises two uprights 14 defined by the portions of the lateral walls of cabinet 3 defining the sides of chute 7. And, for each upright 14, actuating assembly 13 comprises a rail 15 extending along upright 14 down to a stop station 16; and a slide 17 defined by a plate 18 having two pairs of wheels 19 positively engaging rail 15. Slide 17 has a lateral L-shaped appendix 20, to the end of which is connected integrally, by means of a counter-plate 21, a portion of a toothed belt 22 looped about two pulleys 23 fitted in rotary manner to the top and bottom end of rail 15 respectively.

As shown in FIG. 3, the two top pulleys 23 are coaxial, and are made angularly integral with each other by a horizontal output shaft 24 of a step motor 25 fitted to one of rails 15.

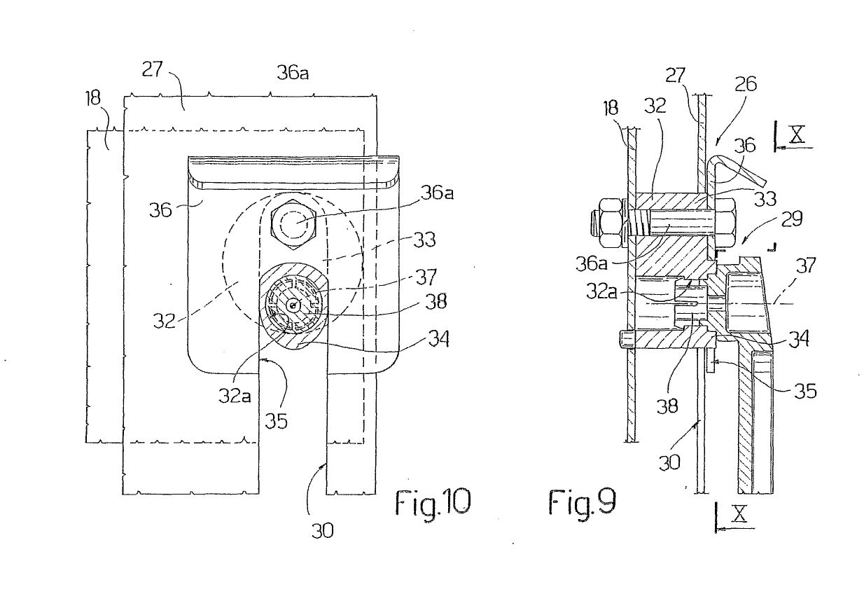

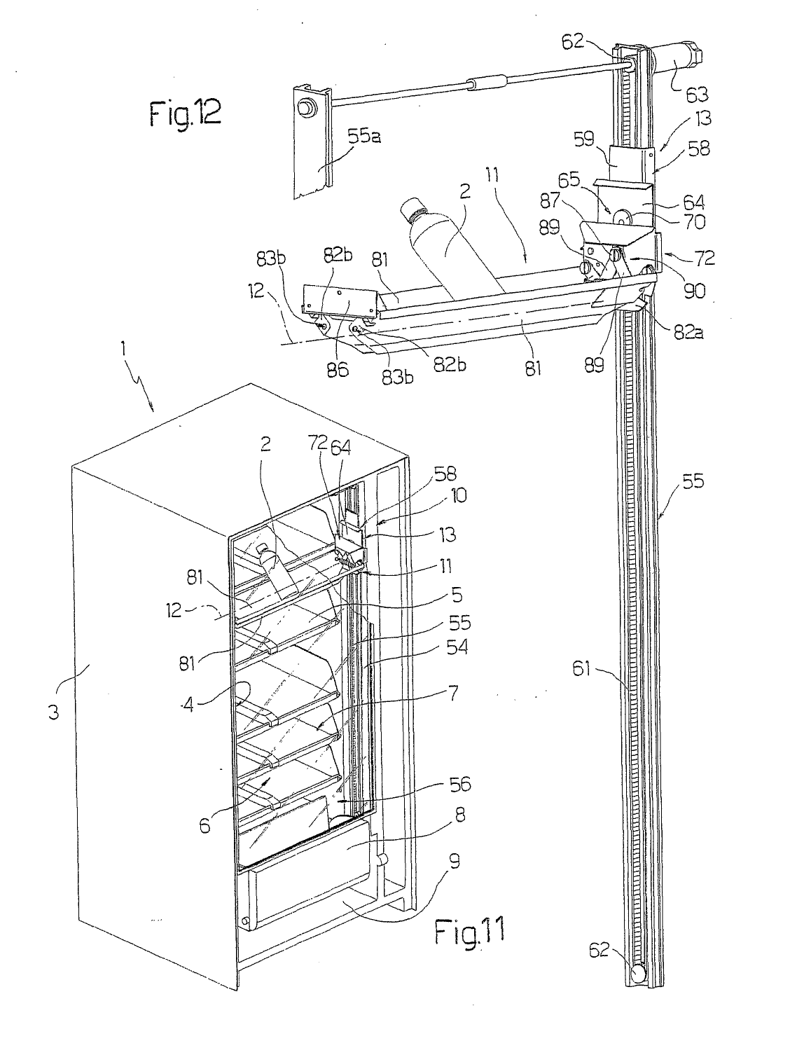

For each upright 14, actuating assembly 13 also comprises a movable assembly 26 defined by a substantially rectangular plate 27, which has two pairs of wheels 28 positively engaging relative rail 15, and is connected to relative slide 17 by a pin-seat gravity coupling 29. Accordingly, as shown more clearly in FIGS. 9 and 10, plate 27 has a slot 30 parallel to a vertical axis 31 (FIG. 6) of relative rail 15 and engaged in sliding manner by a key-like appendix 33, which projects from an end surface of a cylindrical pin 32 fitted to plate 18 and defining said gravity coupling 29 when engaging the top of slot 30.

As shown in FIGS. 9 and 10, a further key-like appendix 34 projects from a bottom portion of the free surface of appendix 33, and engages a vertical, open-bottomed recess 35, which is aligned with slot 30 and formed on the bottom end of a plate 36 connected integrally to pin 32 and plate 27 by a bolt 36a fitted through pin 32, over appendix 34.

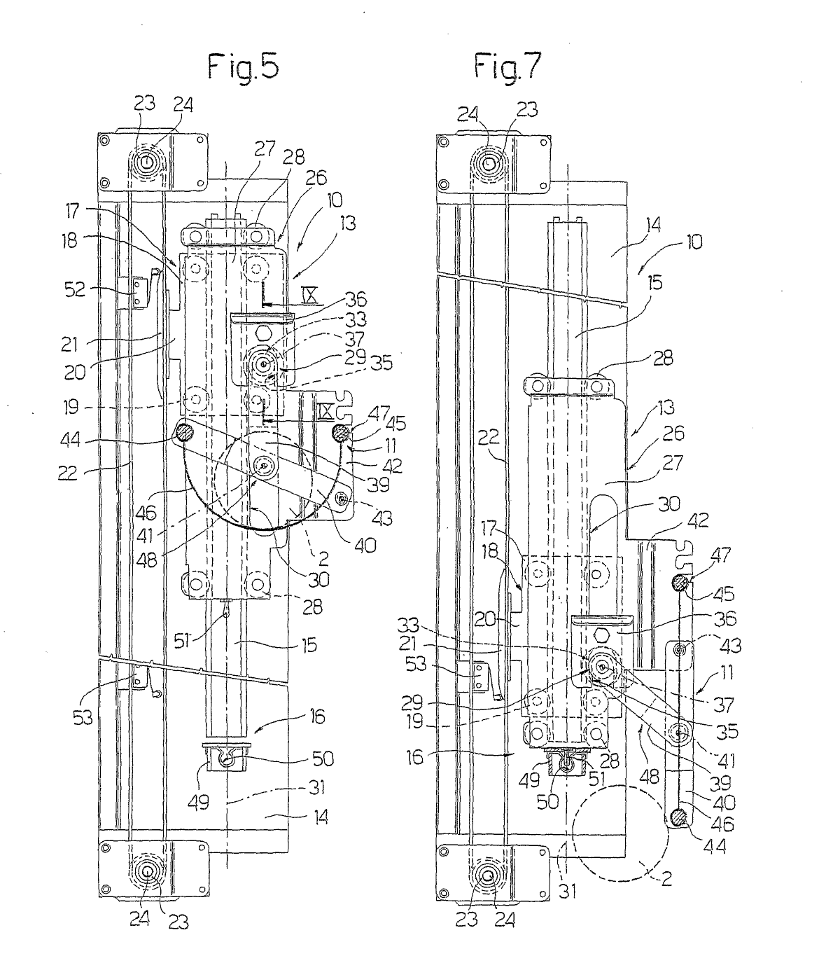

As shown more clearly in FIGS. 5, 6, 8, plate 18 of slide 17 is located between rail 15 and plate 27, which is longer than plate 18—more specifically, is of a length approximately equal to but no less than the total length of plate 18 and slot 30. When movable assembly 26 is positioned with plate 27 resting on edge on appendix 33, i.e. when movable assembly 26 is connected to slide 17 by gravity coupling 29, plate 18 is positioned facing a top portion of plate 27, a bottom portion of which—of a length approximately equal to that of plate 18—projects from the bottom of plate 18.

A through hole 32a is formed through pin 32 and appendixes 33 and 34, and has an axis 37 perpendicular to plates 18, 27 and 36, parallel to longitudinal axis 12, and coaxial with axis 37 of the other upright 14. A pin 38 clicks and is housed in rotary manner inside through hole 32a, and projects from the top end of a lever 39, the bottom end of which is defined by a fork, to which is hinged an intermediate point of a further lever 40 which rotates with respect to lever 39 about an axis 41 parallel to axis 37 and coaxial with axis 41 of the other upright 14.

As shown in FIGS. 5 to 7, lever 40 is hinged at one end to an appendix 42 coplanar with plate 27 and projecting from a vertical lateral edge of plate 27 opposite that facing toothed belt 22, and rotates with respect to appendix 42 about an axis 43 parallel to axis 37 and coaxial with axis 43 of the other upright 14.

As shown in FIG. 4, transfer member 11 comprises two rods 44, 45 parallel to each other and to longitudinal axis 12; and a fabric element 46, or other equivalent flexible member, which is substantially rectangular in planform, and is strung between and connected releasably to rods 44 and 45.

Rod 44 connects levers 40 fitted to the two uprights 14. More specifically, rod 44 is connected, at each end, to the end of relative lever 40 opposite axis 43.

Rod 45 extends between appendixes 42 fitted to the two uprights 14. More specifically, each end of rod 45 is inserted transversely and releasably inside a recess 47 selected from a rack of superimposed recesses 47 formed in a free vertical edge of relative appendix 42, above axis 43.

In other words:

transfer member 11 is connected to slide 17 by an articulated transmission 48 defined by the two levers 39 and 40, as well as to movable assembly 26;

the configuration of transfer member 11 depends on the instantaneous position of slide 17 with respect to movable assembly 26.

In fact, as shown in FIG. 7, the width of element 46 equals the distance between the selected recess 47 and axis 43, plus the distance between axis 43 and rod 44. And, as shown in FIG. 6, when slide 17 and movable assembly 26 are connected by gravity coupling 29, rods 44 and 45 lie in the same substantially horizontal plane above axis 41, and are spaced apart by a distance less than the width of element 46, which therefore assumes a concave configuration, with its concavity facing upwards.

Conversely, as shown in FIG. 5, when slide 17 is moved, with respect to movable assembly 26, towards the bottom end of plate 27, the distance between rods 44 and 45 eventually begins increasing, and reaches a maximum when rods 44 and 45 lie in the same vertical plane, which, in the example shown, extends through axis 43, and element 46 assumes a flat vertical configuration.

As shown more clearly in FIGS. 5 to 7, each rail 15 is fitted at the bottom end with a stop 49, which cooperates with the bottom end of movable assembly 26 to arrest it at stop station 16. Stop 49 has a cavity 50 into which clicks an axial appendix 51 projecting downwards from plate 27 to retain movable assembly 26 elastically in contact with stop 49.

Operation of transfer device 10 will now be described as of the condition shown in FIG. 1, in which transfer member 11 is positioned on a level with a tray 5 supporting a user-selected product 2. In this position, which is always below a top limit position, in which counter-plates 21 activate respective microswitches 52, movable assemblies 26 are supported by respective slides 17 by means of respective gravity couplings 29, so transfer member 11 is maintained in the concave configuration to receive and retain a selected product 2. Given the flexibility of element 46, the selected product tends to settle in a stable, e.g. horizontal, position inside the container defined by element 46.

Once product 2 is unloaded into element 46, motor 25 is operated to move toothed belts 22 and so move slides 17 downwards. As shown in FIG. 5, as slides 17 move down, movable assemblies 26 remain connected to respective slides 17 by means of respective gravity couplings 29, so the relative positions of slides 17 and respective movable assemblies 26 remain unchanged, and element 46 remains in its original concave configuration.

This continues until (FIG. 6) plates 27 come into contact with and engage relative stops 49 by means of respective axial appendixes 51. From which point on, slides 17, still powered by motor 25, continue moving downwards, so that relative appendixes 33 slide down relative slots 30 to rotate levers 40 (anticlockwise in FIG. 6) downwards about relative axes 43 into the FIG. 7 position, which is reached at the same time slides 17 reach a bottom limit position at stop station 16, in which counter-plates 21 activate relative microswitches 53 to stop motor 25.

The overtravel of slides 17 with respect to movable assemblies 26 therefore moves element 46 into the flat unloading configuration, in which element 46 moves up to door 6 to drop product 2 into bin 8 underneath, and, at the same time, leaves chute 7 completely clear, and allows full access to chute 7 by the products 2 on the lower trays 5. This bottom limit position is therefore the position in which transfer member 11 is parked at the end of each operating cycle or, possibly by hand, in the event of a malfunction of transfer device 10.

User selection of another product 2 activates motor 25, and moves slides 17 back up into the pickup position relative to the selected product 2. The overtravel of slides 17 described above is performed in reverse to restore transfer member 11 to the concave configuration before slides 17 are connected to movable assemblies 26 by gravity couplings 29 and move with movable assemblies 26 into the pickup position. The reverse overtravel is simplified by movable assemblies 26 being maintained stationary, until couplings 29 are engaged, by axial appendixes 51 engaging cavities 50 of relative stops 49.

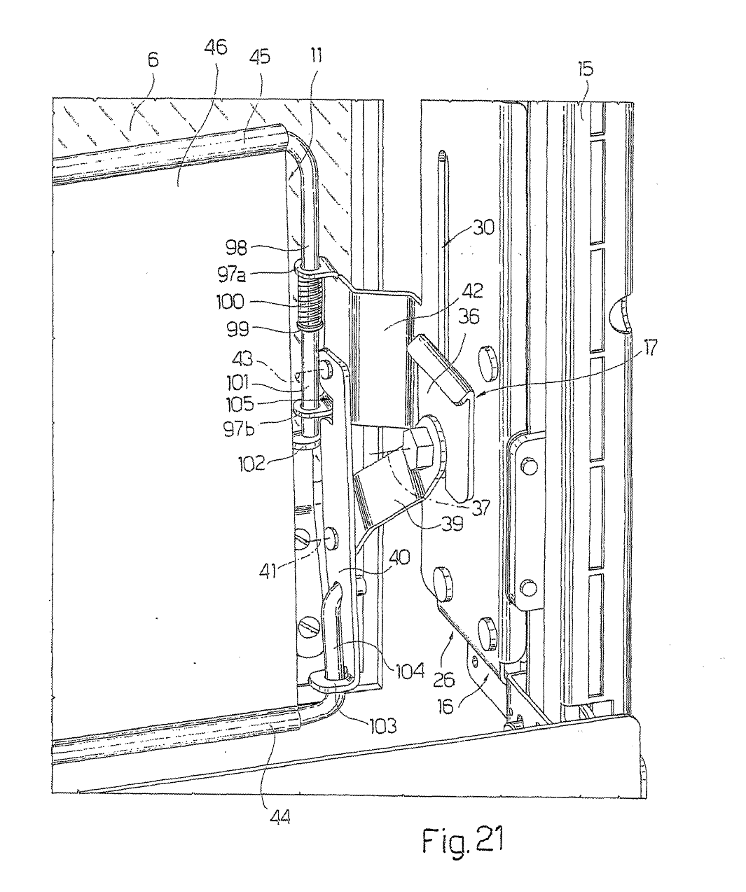

As stated, the width of element 46 and, therefore, the depth of transfer member 11 depend on the width of chute 7, i.e. the distance between door 6 and the front ends of trays 5, and in particular on the length of lever 40. The FIG. 21-24 variation makes the depth of transfer member 11 independent, to a certain extent, of the length of lever 40, so a deeper transfer member 11 can be used.

In this variation, as opposed to the rack of recesses 47 for selectively receiving a respective end of rod 45, each appendix 42 has two lugs 97a and 97b, which extend crosswise to the plane of appendix 42, and have respective holes aligned along a vertical axis parallel to axis 31, and engaged in sliding manner by a rod 98. Rod 98 has an intermediate collar 99 located between lugs 97a and 97b and supporting a spring 100, which is coaxial with rod 98 and compressed between collar 99 and the top lug 97a to keep rod 98 in a normal lowered position, in which collar 99 normally rests on lug 97b (FIG. 22). The top end of rod 98 is bent at a right-angle and connected integrally to a respective end of rod 45 located directly over lug 97a when rod 98 is in the normal lowered position; and, again when rod 98 is in the normal lowered position, a bottom portion 101 of rod 98, roughly equal in length to the distance between lugs 97a and 97b, projects from beneath lug 97b.

Each rod 98 is aligned vertically with a respective stop bracket 102 fitted to door 6 at stop station 16.

Each hinge axis 43 intersects relative appendix 42 at a point between lugs 97a and 97b; and, at its free end opposite axis 43, each lever 40 is bent at a right-angle to form a lug 103, a through hole of which is engaged by a relative right-angle end 104 of rod 44.

In actual use, as movable assemblies 26 move down towards stop station 16, rods 98 are maintained by respective springs 100 in the normal lowered position (FIG. 22), so that rod 45 remains directly over lugs 97a, and element 46 curves downwards to impart a maximum depth to transfer member 11.

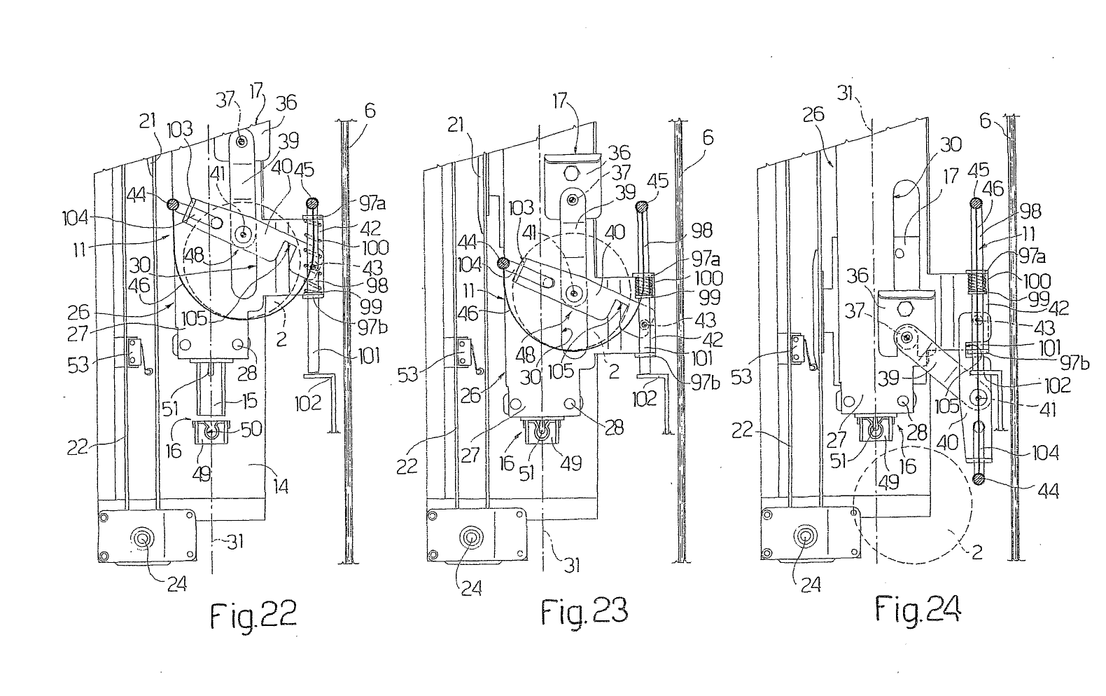

As movable assemblies 26 near stop station 16, the bottom end of each rod 98 rests on respective stop bracket 102, so that, as movable assemblies 26 reach stop station 16 (FIG. 23), rods 98 slide upwards in opposition to respective springs 100, and move rod 45 into a raised position, thus taking up part of the width of element 46.

When rod 45 is in the raised position, the depth of transfer member 11 is substantially the same as that of the corresponding transfer member 11 in FIG. 5, so that the overtravel described of slides 17 allows element 46 to straighten out (FIGS. 21 and 24) into the vertical position completely outside chute 7. To enable element 46 to reach this position, which corresponds to a vertical position of levers 40, levers 40 have respective intermediate slots 105 to prevent levers 40, in the vertical position, from interfering with respective lugs 97b.

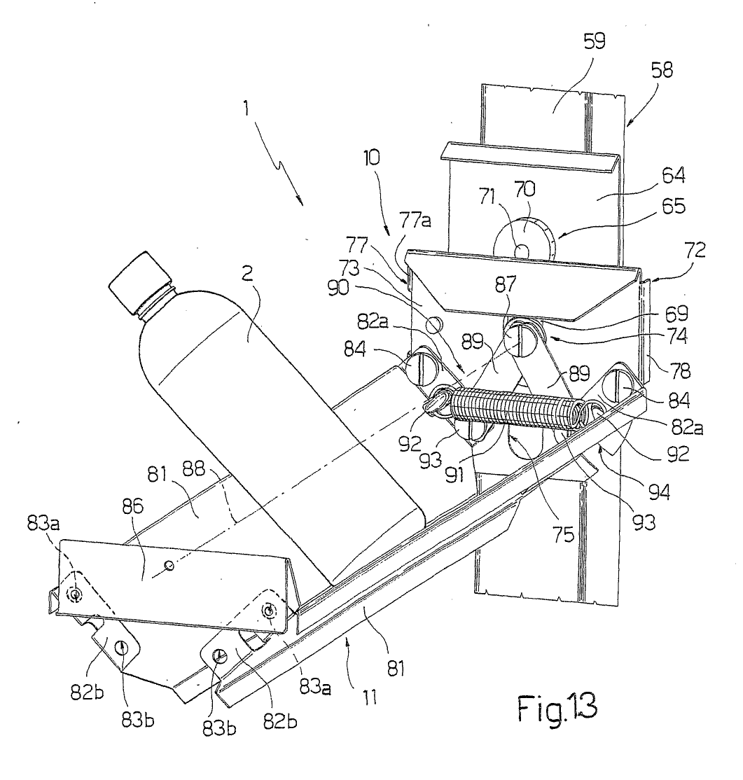

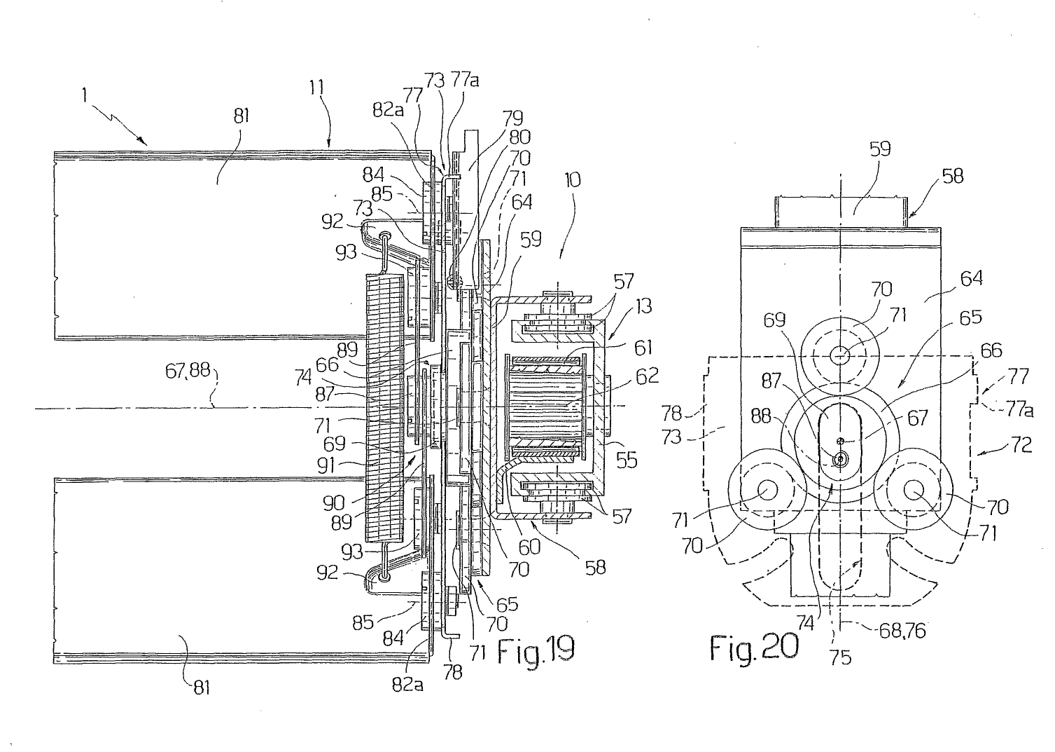

In the FIG. 11-20 embodiment, and as shown more clearly in FIG. 11 and particularly FIG. 12, actuating assembly 13 comprises two uprights 54 (only one shown in FIG. 11) defined by the portions of the lateral walls of cabinet 3 defining the sides of chute 7; and two rails 55 and 55a (FIG. 12) extending along relative uprights 54 down to a stop or unloading station 56. More specifically, as shown in FIG. 14, rail 55 (and also rail 55a, not shown) is defined, as shown in FIG. 19, by a channel section, on the outside of the flanges of which are formed two positive tracks for respective pairs of wheels 57 of a slide 58 (to which corresponds a similar slide (not shown) on rail 55a). As shown in FIG. 19, slide 58 comprises a channel section 59, which encloses the section of rail 55, and has two flanges located outwards of the flanges of rail 55 and supporting respective pairs of wheels 57 in rotary manner. Section 59 has an inner bracket 60 connecting it to a portion of a toothed belt 61 (to which corresponds a similar belt (not shown) on rail 55a) looped about two pulleys 62 fitted in rotary manner to the top and bottom end respectively of rail 55. As shown in FIG. 12, top pulley 62 is connected angularly to a similar top pulley (not shown) of rail 55a by the output shaft of a step motor 63 fitted to rail 55.

Slide 58 (FIG. 19) comprises a plate 64 fitted integrally to the outer surface of the web of section 59 and supporting, on the opposite side to that fitted to section 59, a friction assembly 65 (FIG. 20) comprising a central wheel 66 fitted to plate 64 to rotate idly about a horizontal axis 67 parallel to longitudinal axis 12 and perpendicular to plate 64 and to a vertical axis 68 of upright 54. The opposite surface of central wheel 66 to that facing plate 64 is fitted with an elongated key 69; and friction assembly 65 also comprises three friction rollers 70 tangent to central wheel 66 and fitted to respective pins 71 in turn fitted to plate 64 and parallel to axis 67.

Actuating assembly 13 comprises a movable assembly 72 defined by a substantially rectangular plate 73 connected to relative slide 58 by a sliding pin-seat gravity coupling 74. Accordingly, plate 73 has an axial slot 75, which extends along an axis 76 normally parallel to axis 68, and is engaged in sliding manner by key 69, which is normally located at the top end of slot 75 to support plate 73 on slide 58, and connects plate 73 and central wheel 66 of friction assembly 65 angularly integral with each other.

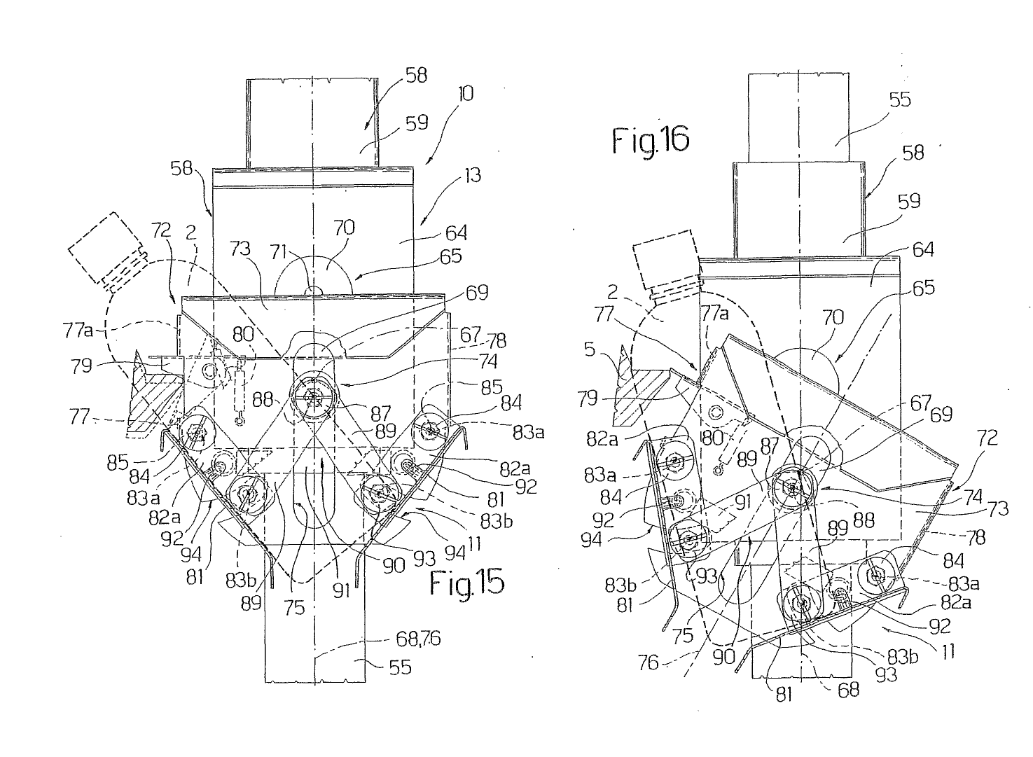

Plate 73 has two lateral edges parallel to axis 76 and bent at right-angles towards slide 58 to form two flanges 77 and 78, of which flange 77 faces the front edges of trays 5 and is divided by a central opening into two portions, the top one of which is indicated 77a. Through the central opening extends the free end of a latch 79, which is fitted to plate 73 to rotate about a pin parallel to axis 67, and is normally maintained by a spring 80 in a position perpendicular to axis 76 and contacting the bottom edge of top portion 77a of flange 77; in which position, latch 79 interferes with the front edges of trays 5, and is free to rotate downwards anticlockwise in FIGS. 15-18.

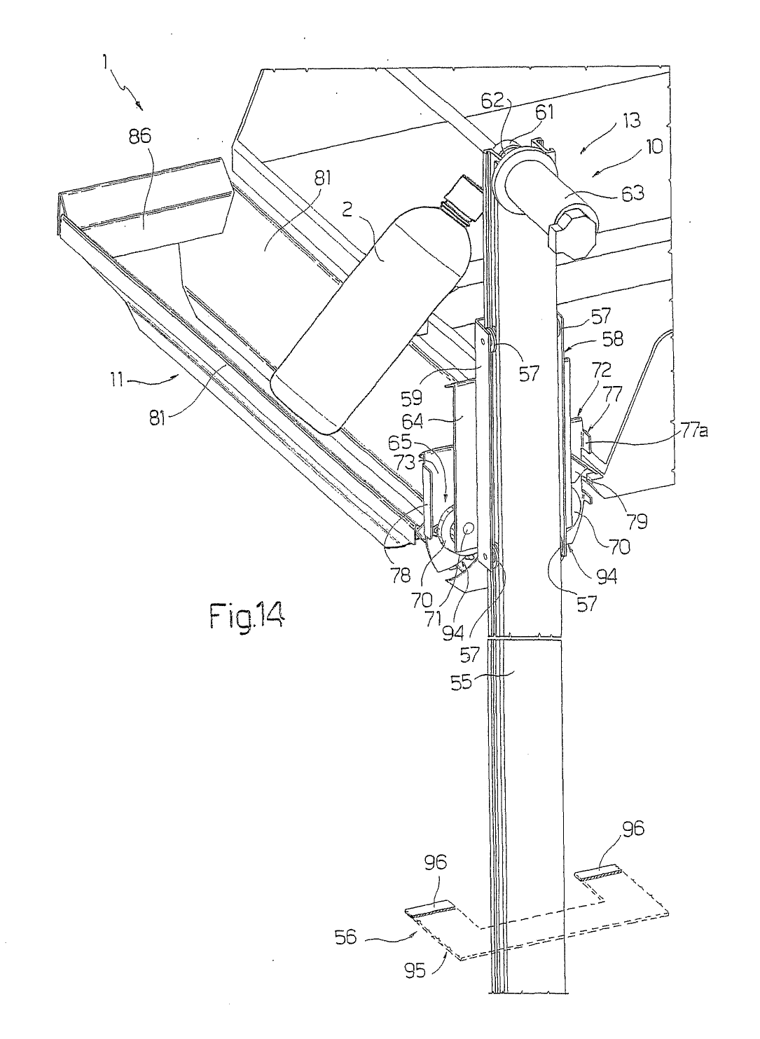

As shown more clearly in FIGS. 12 and 13, transfer member 11 comprises two flat plates 81 located on opposite sides of longitudinal axis 12 and axis 76, and projecting perpendicularly from plate 73 and parallel to longitudinal axis 12. Each plate 81 has two end flanges 82a and 82b bent at right-angles towards the other plate 81, and each having a pair of holes 83a and 83b, with hole 83a located above hole 83b.

Flanges 82a are positioned substantially contacting the outer surface of plate 73, and are hinged to plate 73 by respective pins 84 fitted in rotary manner through respective holes 83a to allow respective plates 81 to oscillate with respect to plate 73 about respective axes 85 (FIG. 19) parallel to longitudinal axis 12. Accordingly, flanges 82b of plates 81 are connected by a crosspiece 86 connected to flanges 82b by pins coaxial with relative pins 84 and relative axes 85, and fitted in rotary manner through relative holes 83a. Crosspiece 86 is hinged centrally (in a manner not shown) directly to the slide (not shown) of rail 55a to oscillate, with respect to the slide (not shown), about axis 88 (FIG. 13).

The free end of key 69 is fitted with a screw pin 87, the axis 88 of which is located below and parallel to axis 67, and defines the hinge axis of two levers 89 of an articulated transmission 90 connecting plates 81 to slide 58, and which controls the angular position of plates 81 in opposition to a spring 91 stretched between two brackets 92, each fitted to relative flange 82a, between relative holes 83a and 83b.

The angular position of plates 81 is controlled by connecting the end of each lever 89, opposite the end fitted with pin 87, to relative flange 82a by means of a respective through screw pin 93, which engages relative hole 83b in rotary manner, and engages in transversely sliding manner a respective curved slot 94 formed through plate 73 and about relative axis 85.

In other words:

transfer member 11 is connected to slide 58 by articulated transmission 90, and to movable assembly 72 by pins 84;

the configuration of transfer member 11 depends on the instantaneous position of slide 58 with respect to movable assembly 72, i.e. on the position of key 69 along slot 75.

In fact, as shown in FIGS. 15 to 18, when key 69 is located at the top end of slot 75 (FIGS. 15-17) and directly supports movable assembly 72 by means of gravity coupling 74, the two levers 89 slope downwards to set the two plates 81 to a V-shaped configuration with the concavity facing upwards; whereas, when key 69 moves towards the bottom end of slot 75 and supports movable assembly 72 by means of pin 87, the two levers 89 are positioned at almost 180° to set the two plates 81 to a parted configuration, in which plates 81 are parallel and vertical.

As shown more clearly in FIGS. 14, 17 and 18, a bottom portion of rail 55 has a stop device 95 comprising two stops 96 located on opposite sides of rail 55, lying in the same plane perpendicular to axis 68, and which cooperate with respective elements, defined by the bottom edges of respective flanges 77 and 78, to arrest movable assembly 72 at stop station 56.

Operation of the FIG. 11-20 transfer device 10 will now be described as of the condition shown in FIGS. 11 and 15, in which transfer member 11 is positioned on a level with a tray 5 supporting a user-selected product 2, and with latch 79 on top of the front edge of tray 5. In this position, movable assembly 72 is supported by slide 58 by means of gravity coupling 74, and key 69 is positioned vertically, so transfer member 11 is maintained horizontal (axes 68 and 76 parallel) in the concave configuration to receive and retain a selected product 2. Given the rigidity of plates 81, as opposed to settling horizontally between plates 81, the selected product fed into the container defined by the two plates 81 comes to rest (FIG. 15) on the outer plate 81 and tilted towards, and in a position of interference with, the lower trays 5 and relative products 2.

Once product 2 is unloaded between plates 81, motor 63 is operated to move toothed belts 61 and so move slides 58 downwards.

As shown in FIG. 16, as slide 58 slides down, the tip of latch 79 interferes with the front edge of the tray 5 from which selected product 2 has been removed, and so rotates the whole of movable assembly 72 outwards about axis 67. This rotation, normally ranging between 20 and 40°, depending on the nature of products 2 and the length of latch 79, produces a corresponding rotation of key 69 and, hence, of central wheel 66 of friction assembly 65 in opposition to the braking action of friction rollers 70, which lock central wheel 66 in its current angular position when, as slide 58 continues moving downwards, latch 79 finally releases the front edge of tray 5.

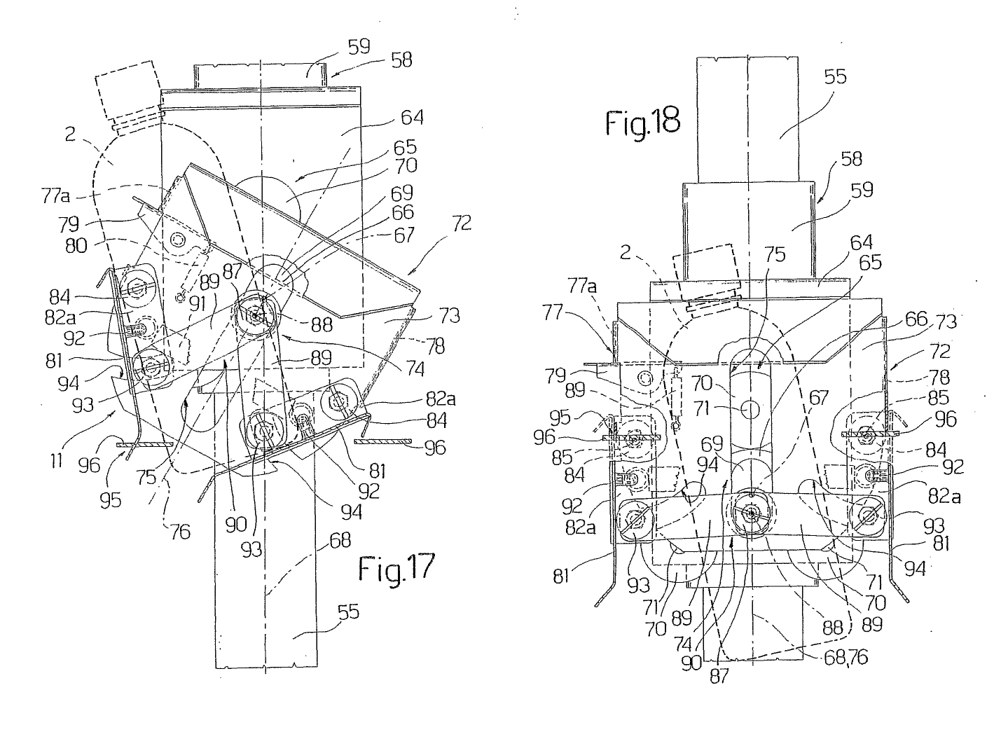

As shown in FIGS. 16 and 17, once tray 5 is overcome, movable assembly 72 therefore moves downwards, maintaining its current outward-tilted position by means of friction assembly 65, and with transfer member 11 in its initial concave configuration. The outward tilt of movable assembly 72 and transfer member 11 moves the selected product 2 inside transfer member 11 into a position of non-interference with the lower trays 5 and relative products 2.

This continues until (FIGS. 17 and 18) the bottom edge of flange 78 contacts relative stop 96 and eases axis 76 back into the vertical position. This rotation (which, in a variation not shown, is assisted by a wheel fitted to flange 78) terminates as the bottom edge of flange 77 also contacts respective stop 96, and movable assembly 72 is arrested at stop station 56 with axis 76 in the vertical position.

From this point on, slide 58, still powered by motor 63, continues moving downwards, so that key 69 slides down slot 75 to rotate levers 89 downwards in opposite directions about respective pins 93 into the FIG. 18 position, which is reached at the same time slide 58 reaches a bottom limit position, in which key 69 almost contacts the bottom end of slot 75, and a stop microswitch (not shown) is activated to stop motor 63.

The overtravel of slide 58 with respect to movable assembly 72 therefore moves transfer member 11 into the open unloading configuration (FIG. 18), in which plates 81 are positioned substantially vertically to drop product 2 into bin 8 underneath, and, at the same time, leave chute 7 completely clear. This bottom limit position is therefore the position in which transfer member 11 is parked at the end of each operating cycle or, possibly by hand, in the event of a malfunction of transfer device 10.

User selection of another product 2 activates motor 63, and moves slide 58 back up into the pickup position relative to the selected product 2. The overtravel of slide 58 described above is performed in reverse to restore transfer member 11 to the concave configuration before slide 58 is connected to movable assembly 72 by gravity coupling 74 and moves with movable assembly 72 into the pickup position.

As movable assembly 72 moves back up, its axis 76 remains vertical, in that, latch 79, though interfering with trays 5, is rotated downwards in opposition to spring 80 and unable to rotate movable assembly 72 in opposition to friction assembly 65.

1) A method of transferring products in a vending machine, the method comprising the steps of:
transferring a selected product from a relative fixed tray of the machine to a transfer member set to a pickup position substantially aligned with said tray;
moving the transfer member along a chute to bring the selected product to a stop station;
unloading the product from the transfer member at the stop station;
controlling the position of the selected product, as it moves down the chute inside the transfer member, by imparting to the transfer member a first concave configuration designed to retain the selected product in a given position;
the step of unloading the product being performed by converting the first configuration of the transfer member to a second configuration, in which the transfer member allows the selected product to drop down the chute, and leaves the chute substantially clear to make it possible to by-pass the transfer member and drop-feed the products down the chute in case of malfunction.

2) A method as claimed in claim 1, wherein the chute extends vertically between a door of the machine and the fixed trays, and is bounded at the bottom by a catch bin of the machine; the selected product being positioned, at said stop station, directly over the bin.

3) A method as claimed in claim 1, wherein the transfer member is moved along the chute by at least one movable assembly carried by a powered slide; the transfer member being connected to both the slide and the movable assembly; and the step of unloading the product being performed by moving the slide and the movable assembly with respect to each other.

4) A method as claimed in claim 3, wherein the movable assembly and the powered slide are kept connected in a fixed position with respect to each other as the transfer member moves along the chute.

5) A method as claimed in claim 4, wherein said fixed position is maintained by gravity.

6) A method as claimed in claim 3, wherein the movable assembly is supported resting on the slide; the slide and the movable assembly being moved with respect to each other by arresting the movable assembly at the stop station and imparting an overtravel to the slide.

7) A method as claimed in claim 1, wherein the transfer member comprises a flexible member, which, in the first configuration, is maintained in a U-folded position with its concavity facing upwards, and, in the second configuration, is maintained in a distended position.

8) A method as claimed in claims 7, wherein the chute extends vertically between a door of the machine and the fixed trays, and wherein, in said distended position, the transfer member is maintained in a substantially vertical plane and close to the door to leave the chute substantially clear.

9) A method as claimed in claim 6, wherein the transfer member comprises a flexible member, which extends between a first member, which is rotated downwards by the slide, about an axis integral with the movable assembly, in the course of said overtravel of the slide, and a second member fitted to the movable assembly.

10) A method as claimed in claim 9, wherein the second member is moved transversely upwards with respect to the movable assembly prior to said overtravel of the slide.

11) A method as claimed in claim 1, wherein the transfer member comprises two plates, which, in the first configuration, are set to a V-shaped position, in which the two plates converge downwards, and, in the second configuration, are maintained substantially parallel to each other and vertical.

12) Al method as claimed in claims 11, wherein the chute extends vertically between a door of the machine and the fixed trays; and the method comprising the further steps of:
moving the transfer member into the pickup position while maintaining the transfer member in a vertical position with its concavity facing upwards;
tilting the transfer member by a given angle towards the door as it moves towards the stop station and substantially as of the pickup position;
restoring said vertical position at the stop station.

13) A method as claimed in claim 12, wherein the transfer member is tilted towards the door by rotating the transfer member about a substantially horizontal axis parallel to the door.

14) A method as claimed in claim 12, wherein said given angle ranges between 20 and 40°.

15) A device for transferring products in a vending machine, the device comprising:
a chute down which the products are fed;
a transfer member for transferring the products along the chute; and
actuating means for moving the transfer member along the chute between a top pickup position to pick up a selected product, and a bottom stop station to unload the selected product;
wherein the transfer member is of variable configuration; the actuating means being connected to the transfer member to alter its configuration, as a function of the position of the transfer member along the chute, between a first concave configuration, to retain the selected product in a given position, and a second configuration, in which the transfer member allows the selected product to drop along the chute, and leaves the chute substantially clear to make it possible to by-pass the transfer member and drop-feed the products down the chute in case of malfunction.

16) A device as claimed in claim 15, wherein the actuating means comprise guide means extending laterally along the chute; at least one movable assembly; and a powered slide supporting the movable assembly and fitted to the guide means to move along the guide means; the transfer member being fitted to both the slide and the movable assembly; and adjusting means being provided to produce a relative movement between the slide and the movable assembly to alter the configuration of the transfer member.

17) A device as claimed in claim 16, wherein the adjusting means comprise stop means, which cooperate with the movable assembly to arrest it at the stop station and allow overtravel of the slide with respect to the movable assembly to produce said relative movement.

18) A device as claimed in claim 17, wherein the movable assembly is mounted to simply rest on the slide and to move with the slide along the guide means; the transfer member being connected to both the slide and the movable assembly to maintain the first configuration when the movable assembly rests on the slide, and to assume the second configuration in the course of said overtravel of the slide.

19) A device as claimed in claim 15, wherein the transfer member comprises a flexible member which, in the first configuration, is in a U-folded position with its concavity facing upwards, and, in the second configuration, is in a distended position.

20) A device as claimed in claim 19, and comprising a first and a second rod parallel to each other and connected to opposite longitudinal edges of the flexible member; and an articulated transmission for connecting the first rod to the slide; the second rod being supported by the movable assembly.

21) A device as claimed in claim 20, and comprising a vertical third rod connected integrally to one end of the second rod and crosswise to the second rod; the third rod being connected to the movable assembly to move, together with the second rod, from a normal lowered position to a raised position in opposition to elastic means and by axial contrast of the third rod with fixed stop means.

22) A device as claimed in claim 20, wherein the articulated transmission comprises a first lever, a first end of which is connected to the movable assembly to oscillate, with respect to the movable assembly, about a first hinge axis parallel to the first rod, and a second end of which is connected to the first rod; and a second lever hinged at one end to the slide to oscillate, with respect to the slide, about a second hinge axis parallel to the first hinge axis, and hinged at the other end to an intermediate point of the first lever.

23) A device as claimed in claim 22, wherein the first hinge axis is located directly below the second rod.

24) A device as claimed in claim 21, wherein the slide and the articulated transmission are located on opposite sides of the movable assembly, which has a slot parallel to the guide means and of a length at least equal to said overtravel; pin means, coaxial with the second axis and fitted to the slide, extending through the slot to connect the second lever in rotary manner to the slide.

25) A device as claimed in claim 15, wherein the transfer member is defined by two plates, which, in the first configuration, are set to a V-shaped position, in which the two plates converge downwards, and, in the second configuration, are maintained substantially parallel to each other and vertical.

26) A device as claimed in claim 25, wherein the plates are hinged at the top to the movable assembly to oscillate about respective horizontal axes of rotation; an articulated transmission being provided to connect each plate to the slide.

27) A device as claimed in claim 26, wherein the articulated transmission comprises, for each plate, a lever hinged at one end to the slide to oscillate, with respect to the slide, about a hinge axis parallel to the axis of rotation of the relative plate and perpendicular to the guide means, and hinged at the other end to a point of the relative plate located below the relative axis of rotation.

28) A device as claimed in claim 26, wherein the slide and the articulated transmission are located on opposite sides of the movable assembly, which has a slot, parallel to the guide means and of a length at least equal to said overtravel, for the passage of hinge means fitted to the slide to connect each said lever to the slide.

29) A device as claimed in claim 28, wherein said hinge means comprise a key engaging the slot in transversely sliding manner; and a pin fitted to the key, coaxial with the hinge axis, and fitted to the two levers of the articulated transmission.

30) A device as claimed in claim 29, wherein said hinge means also comprise a friction assembly interposed between the key and the slide to allow the movable assembly to tilt, and remain tilted, by a given angle with respect to the slide by rotating about a further axis parallel to the hinge axis.

31) A device as claimed in claim 30, wherein said given angle ranges between 20 and 40°.

32) A device as claimed in claim 30, wherein latch means are carried by the movable assembly to interfere with the trays, as the slide moves from the pickup position towards the stop station, to rotate the movable assembly by said given angle with respect to the slide.

33) A vending machine comprising:
a compartment;
a number of fixed trays arranged one over the other inside the compartment;
a substantially vertical door closing the compartment;
a catch bin for a selected product; and
a device, as claimed in claim 15, for selectively transferring selected products from respective locations on the fixed trays to the bin along a chute extending vertically between the door and the fixed trays and bounded at the bottom by the bin.

34) A vending machine as claimed in claim 33, wherein the transfer member comprises a flexible member which, in the first configuration, is in a U-folded position with its concavity facing upwards, and, in the second configuration, is in a distended position; and wherein, in said distended position, the transfer member is maintained in a substantially vertical plane and close to the door.

35) A vending machine as claimed in claim 33, wherein the actuating means comprise guide means extending laterally along the chute; at least one movable assembly; and a powered slide supporting the movable assembly and fitted to the guide means to move along the guide means; wherein the movable assembly is mounted to tilt and remain tilted, by a given angle with respect to the slide, towards the door.
